(19) United States
(12) Patent Application Publication
(10) Pub. No.: US 2005/0028688 A1
(43) Pub. Date: Feb. 10, 2005

(54) Baling press for producing cylindrical bales

(75) Inventor: Daniel Eric Derscheid, Ottumwa, IA (US)

Correspondence Address: Jimmie R. Oaks;Patent Department, DEERE & COMPANY, One John Deere Place, Moline, IL, 61265-8098, US

(73) Assignee: Deere & Company, a Delaware corporation

(21) Appl. No.: 10/896,264

(22) Filed: Jul. 21, 2004

(30) Foreign Application Priority Data
Aug. 6, 2003 (DE) 103 35 883.8

(51) Int. Cl. B30B 5/04; B30B 9/00; B30B 5/06; B30B 3/04

(52) U.S. Cl. 100/88; 100/87; 100/89

(57) ABSTRACT

A large round baler includes a tensioning arm to which is mounted two cylindrical rolls between which extend a loop of each of a plurality of side-by-side, bale-forming belts. Two belt support pulleys are located in an upper region of the baling chamber above the tensioning arm, and alternate loops respectively of the plurality of bale-forming belts are respectively engaged about one and another of said two support pulleys, so as to form gaps between adjacent loops through which material entrapped in a given loop may exit.

### FIELD OF THE INVENTION

The invention relates to a round bale press having a belt-tensioning device, cylindrical rolls rotatably mounted on the tensioning device, at least one belt pulley, and belts for a baling chamber which belts extend in at least one loop between said rolls and over the pulley.

### BACKGROUND OF THE INVENTION

Known large round balers (DE 199 41 604) include a variable baling chamber including a vertically swingable tensioning arm with two rolls, wherewith bale-forming belts can pass between the rolls and can be passed around a fixed belt pulley. Depending on the positioning of the tensioning arm, the size of the baling chamber can be varied.

A problem which is associated with the known large baler is that the loop can collect some of the crop material which is being baled, and this can lead to jamming and the like.

### SUMMARY OF THE INVENTION

According to the present invention, there is provided an improved variable sized, baling chamber arrangement.

An object of the invention is to provide a baling chamber arrangement including a tensioning arm carrying at least two cylindrical rolls, and at least two belt pulleys, and wherein a plurality of bale-forming belts are mounted in side-by-side relationship, with each belt extending in at least one loop between the two rolls and over one of the belt pulleys.

In the described solution, a plurality of mutually displaced belt loops are provided, so that material which has become entrapped can exit laterally; instead of leading to jamming. The belt tensioning device can have any of a wide range of configurations. For example, it may comprise translationally movable rolls or the like. It is conceivable that two belts may be guided differently, i.e., each having a different guide path; however, it is also possible for the belts to be combined in groups, with one group passing around one roll and another group passing around the other roll.

A swingable tensioning device, which, for example, has an arm disposed on each side of the baling chamber, which rotatably bears the ends of the rolls, is particularly advantageous, because its swinging movement causes the loops to be moved with respect to each other, and thereby the loop openings are caused to be periodically enlarged.

The risk of jamming can also be reduced as a result of an arrangement wherein the gap between the rolls is changeable during the pressing process; e.g., if the rolls are swingably mounted on the tensioning device and their position can be adjusted by a lever system, a cable, a motor, or the like (see DE 42 15 308 C2).

On the other hand, a single prescribed separation distance which is not changeable during operation can be brought to a minimum value and maintained, so that the risk of winding of spurious material is minimized due to a minimal gap in the baling chamber.

Additional open spaces for lateral escape of entrapped crop material and/or for alternative configuration of the paths of the belts can be provided if a roll and/or a pulley extends over the width of only a few of the belts. This can be achieved, e.g., by employing rolls or pulleys which are mounted at only one end to the tensioning device or the chassis

### BRIEF DESCRIPTION OF THE DRAWINGS

In the drawings, an exemplary embodiment of the invention is illustrated, which is described in more detail below.

FIG. 1 is a schematic right side view of a round baler having belts supported in a configuration in accordance with the invention.

FIG. 2 is a perspective view of the belts shown in FIG. 1.

### DESCRIPTION OF THE PREFERRED EMBODIMENT

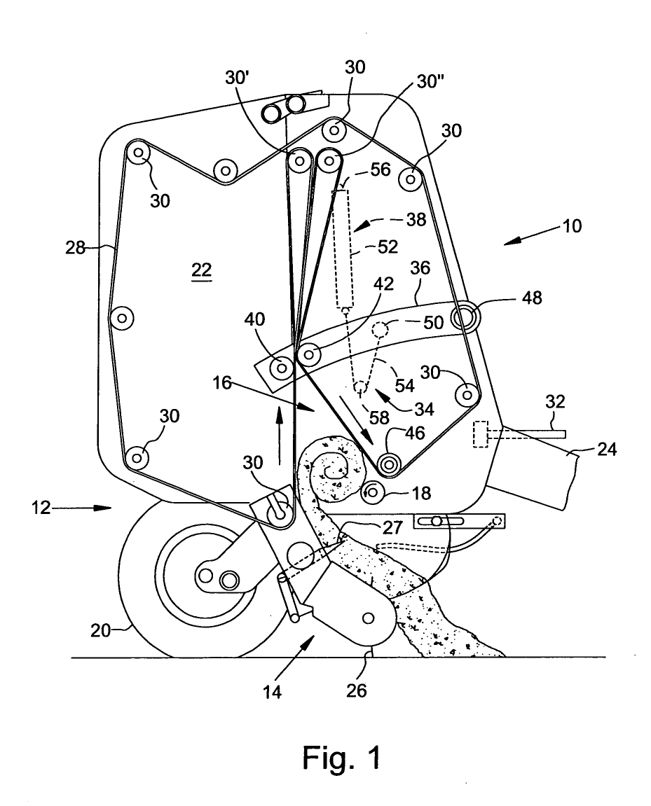

A large round baler 10, illustrated in FIG. 1, has a chassis 12 and a feed device 14 which conveys the crop materials which are to be baled, into a baling chamber 16 of variable size. The baling chamber 16, which initially has an essentially triangular shape, is penetrated in the forward lower region by a so-called starter roll 18, which assists in causing the accumulated material to be baled to rotate. In other embodiments of round balers, one may dispense with the starter roll 18. The chassis 12 is supported by wheels 20 which can travel over the ground, and has side walls 22, which laterally delimit the baling chamber 16. At the forward side of the chassis 12, a tow bar 24 is provided by which the round baler 10 can be connected to a towing vehicle. The feed device 14 is comprised of a tined reel 26 which picks up the crop materials from the ground and conveys them upward and rearward to a feeder device 27, which introduces the crop material into the baling chamber 16. The baling chamber 16 is surrounded on its periphery by a plurality of belts 28 which extend mutually parallel and each of which is relatively narrow. The belts 28 act upon and form the crop materials into a cylindrical bale. The belts 28 are guided over a plurality of pulleys 30, which extend between, and have opposite ends mounted on, the side walls 22. Two of the pulleys, namely pulleys 30′ and 30″ are of particular importance and will be described in more detail later. The belts 28 are moved by rotational driving of at least one of the pulleys 30, 30′ or 30″. A drive shaft 32 is provided for this purpose, which shaft can be connected to the towing vehicle. In addition, a tensioning device 34 is provided which in principle is essentially; known.

The tensioning device 34 includes a respective tensioning arm 36 disposed on each side wall 22 and further includes a tensioning member 38 and rolls 40 and 42.

Whereas in this exemplary embodiment two tensioning arms 36 are provided, in other embodiments a single tensioning arm may suffice. Each tensioning arm 36 extends parallel to the side walls 22. Normally, but not mandated, the tensioning arms 36 are disposed between the side walls 22. In a forward end region of each tensioning arm 36, the arm is swingably mounted on a forward, approximately mid-height region of the chassis 12, or side walls 22, by a bearing 48. Each tensioning arm 36 extends horizontally to the rear to a point past the midpoint of the baling chamber 16. Each tensioning arm 36 is provided with a connection 50 for the tensioning device 38.

In the exemplary embodiment shown, the tensioning device 38 is comprised of a spring 52 and tensile means 54, and has the task of constantly urging the tensioning arm 36 into its lowermost position, in which the belts 28 are under minimum tension, with the tension increasing as the arm 36 moves upward toward the pulleys 30′ and 30″.

The spring 52, shown in FIG. 1, is a mechanical helical tension spring, but it may comprise hydraulic or pneumatic means, realized via, e.g., pressure reservoirs, valves, and the like. It is per se known in multifarious forms. The spring 52 is fixed in its upper end region in a bearing or support 56 on the corresponding side wall 22 of the chassis 12.

The tensile means 54 may be a chain or cable, one end of which is fixed to the lower end region of the spring 52, and the other end of which is fixed to the connection 50. The tensile means 54 between its ends is passed around a guide pulley 58 on the side walls 22, whereby an upwardly directed movement of the tensioning arm 36 causes upward movement of the connection point 50 of the tensile means 54, which, in turn, results in extension of the helical tension spring 52.

The rolls 40 and 42 are rotatably mounted on the end region of the tensioning arm 36, which end region occupies the center of the baling chamber 16, and said rolls extend over the entire width of the baling chamber 16. They are mutually parallel and are spaced a small distance apart. The rolls 40 and 42 form a combination, and serve to keep the size of the baling chamber small, to provide high density in the bales being formed from the pressed crop. A roll 46 is somewhat distant from the other rolls and serves as a lower direction-change point for the belt 28 which comes from above and departs generally upwardly.

The tensioning device 34 may have additional features which are per se known, and will not be described in detail. For example, these features may include a connection between the two tensioning arms 36 to cause them to move simultaneously, control means for causing the formation of soft centered bales, control means for the belt tension during expulsion of a bale from the baling chamber 16, etc.

The pulleys 30′ and 30″ are disposed generally above the set of rolls 40 and 42, namely in the upper end region of the side walls 22 in the vicinity of a support which joins the walls 22. The individual pulleys 30′ and 30″ serve as a direction change point for the belt 28 which comes from below and departs downwardly, wherewith the belt forms a loop around a given one of these pulleys. The two pulleys 30′ and 30″ are mutually parallel, and are separated by a small distance in the exemplary embodiment shown (in other embodiments, the separation between the pulleys 30′ and 30″ may be larger).

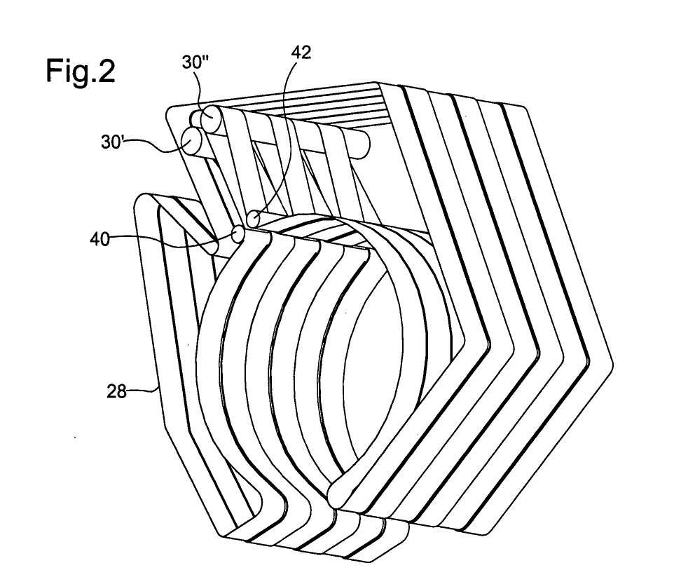

Reference is now made to FIG. 2, from which one may see the course of the belts 28 over and between the rolls 40 and 42, and over the pulleys 30′ and 30″. All other parts have been eliminated from this view, for the purposes of clear illustration.

The principle of the invention is that, in contrast to the state of the art, not all of the belts pass over a single common pulley 30, but rather, alternate belts pass over the individual pulleys 30′ and 30″, which leads to the displacement of the laterally neighboring belt elements.

In a preferred exemplary embodiment, proceeding from right to left in FIG. 2, a first one of the endless belts 28 is passed between the rolls 40 and 42 and over the pulley 30′, and a sequentially next belt 28 is passed between the rolls 40 and 42 and over the pulley 30″. Then, the first path is availed, and then the second, and so on.

As seen in particular from FIG. 2, there is in the opening between the rolls 40 and 42, a gap which extends over the entire width of the baling chamber 16. Beyond this gap, the individual loops diverge, whereby any crop material which may have been captured can escape or can be removed, or can be reduced in size, i.e., broken up, between the belts 28, whereby the hazard of winding such material around the pulleys and rolls of the belt driving and guiding system is substantially reduced.

In the exemplary embodiments which have been illustrated and described, it is assumed that the pulleys 30′ and 30″, and the rolls 40 and 42 extend over the entire width of the baling chamber 16. This is not a mandatory requirement. Rather, pulleys and rolls supported at only one end may be used, and these pulleys and rolls may extend over only some but not all of the belts 28.

Having described the preferred embodiment, it will become apparent that various modifications can be made without departing from the scope of the invention as defined in the accompanying claims.

1. In a large round baler including a wheeled chassis and having a baling chamber delimited at its opposite sides by side walls carried by said chassis, a tensioning device located between and mounted to one of said side walls or chassis for movement against a tensioning force, said tensioning device including two cylindrical rolls, and a plurality of bale-forming belts being arranged in side-by-side relationship to one another and each having a loop extending between said two cylindrical rolls, the improvement comprising: two pulleys rotationally mounted to at least one of said side walls at an upper region of said baling chamber; and the loop of each of some of said plurality of belts extending over one of said two pulleys and the loop of others of said plurality of belts extending over another of said two pulleys.

2. The large round baler, as defined in claim 1, wherein said tensioning device has a tensioning arm which is mounted to one of said side walls and chassis for pivoting vertically; and said two cylindrical rolls being mounted to said tensioning arm.

3. The large round baler, as defined in claim 1, wherein a distance between said two cylindrical rolls and said two pulleys diminishes and said tensioning force increases as a bale increases in size within said baling chamber.

4. The large round baler, as defined in claim 1, wherein a distance between said cylindrical rolls remains fixed during baling operation.

5. The large round baler, as defined in claim 1, wherein at least one of said two rolls and two pulleys extends only partially over a distance between said side walls.
